(19) United States
(12) Patent Application Publication
(10) Pub. No.: US 2013/0029027 A1
(43) Pub. Date: Jan. 31, 2013

(54) Pet Food Composition

(71) Applicants: Anita P. Vincent, Jerome, ID (US); Eric D. Bastian, Twin Falls, ID (US); George Gregory Griffin, Springfield, MO (US); Tommy Ray Willard, Moore, SC (US)

(72) Inventors: Anita P. Vincent, Jerome, ID (US); Eric D. Bastian, Twin Falls, ID (US); George Gregory Griffin, Springfield, MO (US); Tommy Ray Willard, Moore, SC (US)

(73) Assignee: Glanbia Nutritionals (Ireland) PLC, Kilkenny (IE)

(21) Appl. No.: 13/356,616

(22) Filed: Jan. 23, 2012

Related U.S. Application Data
(60) Provisional application No. 61/435,343, filed on Jan. 23, 2011.

(51) Int. Cl. A23K 1/18; A23K 1/10

(52) U.S. Cl. 426/583; 426/630; 426/641; 426/520

(57) ABSTRACT

Disclosed is a composition and method which facilitate increased incorporation of meat into a dry food product, such as an extruded pet food kibble. Products made by incorporating the composition provide increased resistance to breakage, excellent palatability, and increased nutritional value.

This application claims the benefit of priority of U.S. Provisional Patent Application No. 61/435,343, filed Jan. 23, 2011, which is incorporated herein by reference where allowed by applicable law/and or regulation.

### FIELD OF THE INVENTION

The invention relates to pet food and similar compositions which are formed by extrusion or baking. More specifically, the invention relates to extrusion-processed pet food compositions comprising kibble having high meat content and methods for producing such compositions.

### BACKGROUND OF THE INVENTION

Pets have become an integral part of the lives of people around the globe. While some pet owners cook food for their pets, the vast majority purchase commercially-available pet foods, such as canned foods and kibble, to meet the nutritional needs of their pets. Global pet food sales in 2009 reached approximately 52 billion U.S. dollars, with much of those sales being attributed to dog and cat foods. Most commercially-available pet food comes in a dry form (often known as “kibble”), a semi-moist form, or a wet (e.g., canned) form. Extruded and baked treats and supplements also form a major portion of the pet food market. Treats and supplements may be extruded, baked, or formed under pressure, freeze dried, or frozen and are generally formed of more expensive ingredients than are kibble products. Dry pet food generally contains 6-10 percent moisture by volume, as compared to 75-92 percent in canned food. Dry food is considered to be more nutritionally dense than canned food because it has lower moisture content. Pet food kibble accounts for more than 60 percent of all cat food and dog food sales in the United States, for example, and is packaged in paper, film, foil, boxes or laminated containers of these materials, ranging is sizes of a few ounces to larger bags weighing up to 50 pounds.

Kibble and the majority of treats are either extruded or baked. Extrusion is a continuous cooking process, using water, high pressure steam and mechanical sheer under and up to several atmospheres of pressure. During the extrusion process, the raw material for the kibble consist of various sources of animal, plant, vegetable, organic and inorganic minerals, vitamins and purified amino acids, and may be blended with raw meats. Nutritionally the kibble, whether extruded or baked, contains the six major nutrient categories of protein, fat, fiber, carbohydrates, minerals and vitamins. Starches and fibers in the raw material are gelatinized during extrusion cooking, becoming more soluble and absorbing large quantities of water. Absorption of water by the starch component promotes expansion of the product and binds the ingredients into a shaped Palatable and nutritional matrix for easier feeding. The kibble, generally containing about 20-25 percent moisture at this point, is dried to a level of about 8 to 10 percent moisture. Once formed, kibble is often sprayed and/or dried with vitamins, fats, oils, or any other ingredients that may not be heat-tolerant, to complete both the nutritional and palatability properties of the food.

Following a scientifically prepared recipe, the extrusion process consists of the raw materials first being ground to an appropriate particle size, which may vary according to the cooking process and the ingredients. Ingredients forming a “dry mix” are passed through a pre-conditioner, where water, fats and oils may be added. Steam is injected at this point to start the cooking process. The pre-conditioned mix is then passed through an extruder, and forced through a die where it is cut to the desired length. The cooking process produces gelatinization of the starch as well as sterilization of the product.

The addition of fresh meat adds significant moisture and fat to the process, creating cooking and hydration problems in both the pre-conditioner and extruder. Recipes with levels of fresh meat in excess of 20 percent generally result in extruded kibbles that may be very soft and easily deformed, crushed or broken. If high levels of fibrous material are added to the recipe, it tends to disrupt the carbohydrate matrix of the product and give a rough appearance to the product, as well as an excessive amount of fines. If the levels of starch are too high, they create problems with the extrusion process, produce increased levels of fines, and result in significant levels of kibble breakage. Therefore, selection of ingredients for dry extruded food products requires careful analysis. One approach that has been taken to increase the amount of meat that may be incorporated into kibble has been described in U.S. Pat. No. 6,410,079 (Cheuk, et al.). Cheuk et al. disclose a method for increasing the meat content of dry pet food (i.e., kibble) by the addition of an amount of cellulosic material effective to allow extrusion and cutting of the resulting product. While this disclosure provided an improvement in the pet food industry, the addition of cellulose to increase the meat content of dry food, often desirable in certain formulations such as those for weight loss and glucose management, is not generally desirable because cellulose is significantly less digestible, providing only a negligible contribution to the energy available from the food. Cellulose is fairly similar to starch on a gross energy basis, but the metabolizable energy is almost zero. Sufficiently high levels of cellulose in a pet's diet may also negatively affect the digestibility of other nutrients, such as protein and minerals. Furthermore, adding cellulose to the diet generally increases fecal volume.

Meat provides a full amino acid profile to the animal consuming it, and pet owners generally want to incorporate more meat into their pets' diets to improve both the nutrition and palatability of the food. Kibble, however, provides a more convenient, longer shelf-life product that is more nutrient-dense because of its lower percentage of water. It would therefore be beneficial to provide higher levels of meat in a dry pet food product than those levels that are achievable in commercial products today. It would be even more desirable to develop a method for incorporating more meat into a dry pet food product using one or more compositions that can add their own nutritional value to the food.

### SUMMARY OF THE INVENTION

The present invention relates to a composition comprising from about 30 percent to about 80 percent fine-milled flax seed and from about 20 percent to about 70 percent whey protein concentrate (WPC), by weight. In various aspects, a composition of the invention may comprise from about 55 to about 70 percent fine-milled flaxseed and from about 30 to about 45 percent WPC.

Aspects of the invention also relate to a pet food composition comprising from about 20 to about 90 percent by weight of at least one meat product, and a flaxseed/WPC component, wherein the flaxseed/WPC component comprises from about 30 percent to about 80 percent fine-milled flax seed and from about 20 percent to about 70 percent WPC, by weight of the flaxseed/WPC component, and the flaxseed/WPC component is present in an amount of from about 1.5 percent to about 18.5 percent by weight of the meat. In certain aspects, such a pet food composition may comprise a flaxseed/WPC component comprising from about 55 to about 70 percent fine-milled flax seed and from about 30 to about 45 percent WPC, by weight of the flaxseed/WPC component.

The invention also relates to a method for increasing the meat content of an extruded food composition, the method comprising admixing the meat and a flaxseed/WPC component to form a meat/flaxseed/WPC mixture, the flaxseed/WPC component comprising from about 30 percent to about 80 percent fine-milled flaxseed and from about 20 percent to about 70 percent WPC, by weight of the flaxseed/WPC component, and the flaxseed/WPC component being added at from about 1.5 percent to about 18.5 percent by weight of the meat; holding the mixture for from about 3 to about 30 minutes at from about 35 to about 60 degrees Celsius, and processing the mixture by extrusion cooking.

In some aspects of the invention, the flaxseed/WPC component is admixed with the meat and held at from about 45 to about 55 degrees Celsius, and in some aspects, the holding time is from about 10 minutes to about 30 minutes. In some aspects, the extruded food composition is an extruded pet food composition.

### BRIEF DESCRIPTION OF THE DRAWINGS

FIG. 1 is a bar graph illustrating the stool grade (shown on the X axis) distribution for animals consuming a higher-meat product of the invention. A grade of 4 is considered maximal and desirable, representing a stool that is of reasonable firmness. The number of observations is indicated on the Y axis.

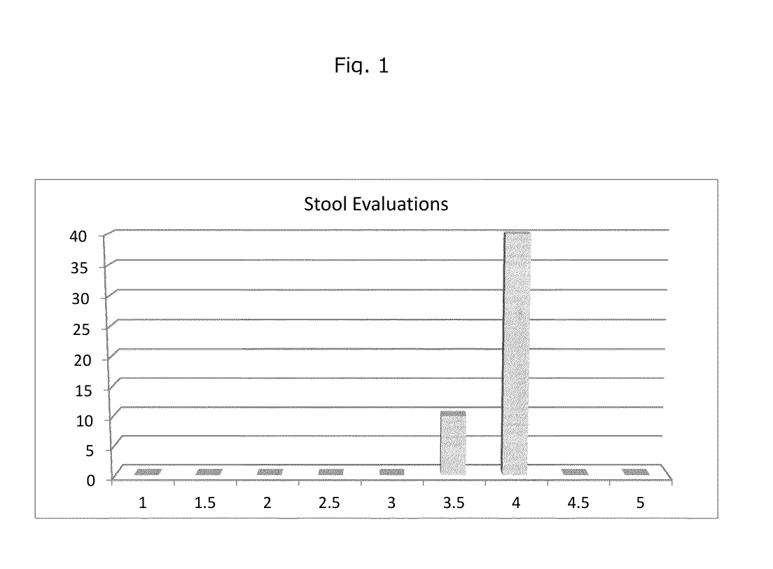

FIG. 2 is a bar graph illustrating the ratio of selection frequency of a leading, premium extruded dry food (Eukanuba®, Procter and Gamble, Cincinnati, Ohio) as compared to that of the composition of the invention. “Premium” designates results for the Eukanuba® product and “Glanbia” designates results for the composition of the invention. Side-by-side selection studies were performed, with results expressed as the ratio of frequency of selection of one product over the other when animals were given a choice between the two products. Results for dog foods are shown in the top graph. Results for cats are shown in the bottom graph. As illustrated by these results, the product of the invention has improved palatability.

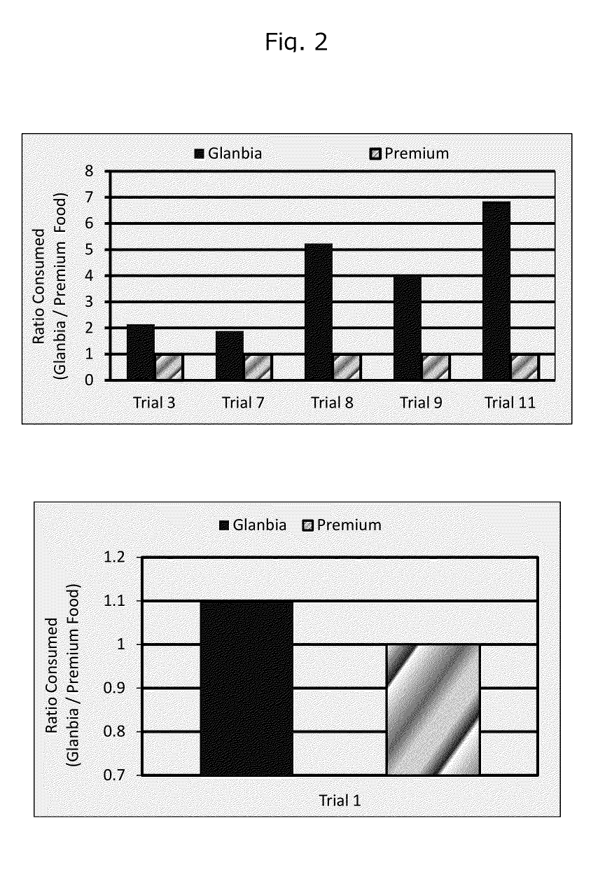

FIG. 3a is a graph representing the low, average, and high values of the amount of force applied to kibble to test for breakage. FIG. 3b is a graph representing the percentage of fines produced in a series of tests. It should be noted that the maximum percentage shown on the graph is still less than one Percent.

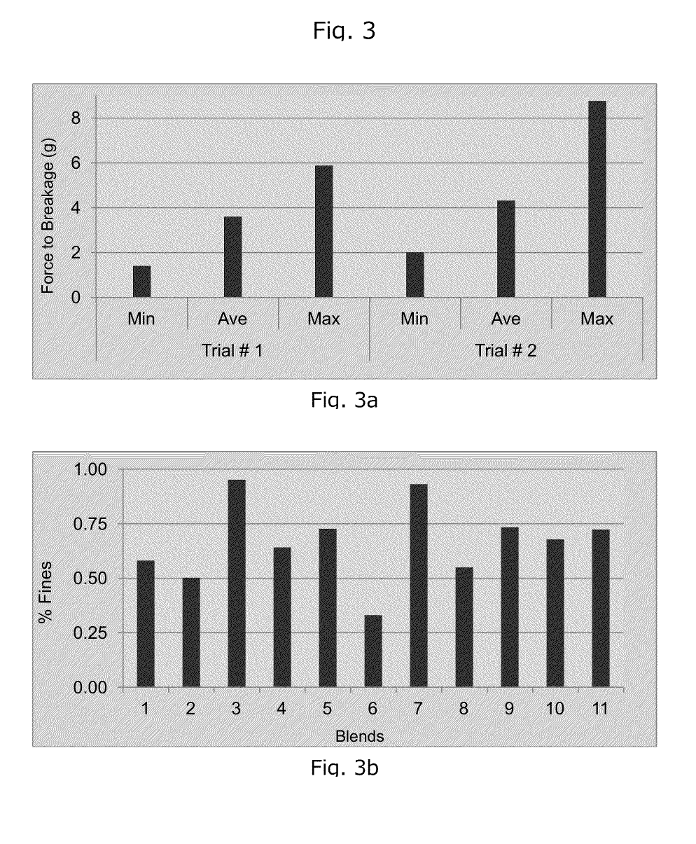

### DETAILED DESCRIPTION

The inventors have discovered that the combination of two nutritionally-valuable components—whey protein concentrate and flaxseed—can be used as functional ingredients to increase the amount of meat that may be incorporated into a dry food composition, especially an extruded dry pet food composition. By mixing the flaxseed/whey protein concentrate composition with meat, it is possible to make the meat easier to process, providing a product with higher meat content and improved properties for an extruded food product, such as an extruded pet food product.

As used herein, a “meat” or “meat product” is raw, partially cooked, or cooked flesh including, but not limited to, beef, pork, chicken, turkey, fish, etc. Generally, raw meat is commonly used in the preparation of many products such as pet food compositions produced by extrusion cooking. “Flaxseed” is generally a fine-milled flaxseed, and may preferably be a full-fat fine-milled flaxseed.

Formed pet food compositions may be produced by baking or by extrusion cooking. The extrusion method generally subjects the food components to high pressure and temperature, gelatinizing the starch that may form a component of the food ingredients. High levels of starch, however, cause problems in the extrusion process and produce a product that is higher in pieces broken into very small pieces, known in the industry as “fines.” High levels of meat in an extruded dry product generally produce a denser product with a lower Percentage of cook, or gelatinization, resulting kibble that is softer, less crunchy, and more deformable.

The inventors have developed a composition that facilitates incorporation of greater quantities of meat into extruded and baked dry food products. The composition also provides significant added benefits, such as the addition of beneficial nutrients such as branched-chain amino acids, omega-3 (alpha-linoleic) and omega-6 (linoleic) fatty acids, and gamma-tocopherols to the food products. Animals fed compositions of the invention demonstrated a significant preference for the food product, indicating that it is of greater palatability to the animals. The effect appeared to be more pronounced in dogs than in cats, but was seen in both species. Feeding compositions of the invention to dogs or cats resulted in stools of desirable firmness. Furthermore, compositions of the invention also demonstrated a kibble strength and texture that would generally be considered by those of skill in the art in the pet food industry to provide a dental benefit to the animal consuming the composition. Also, processing compositions of the invention requires less motor load on the extrusion equipment and may increase the processing time and efficiency.

Adding cellulosic material to an extruded pet food composition in order to increase the meat content has been previously described. However, high levels of fibrous ingredients may disrupt the continuity of the product's carbohydrate matrix, resulting in the production of a kibble product that is rougher in appearance, easier to break, and produces excessive fines. The inventors therefore hoped to find an ingredient, or combination of ingredients that might solve that problem and produce a kibble product having higher meat content, while maintaining the desirable kibble characteristics of moisture level, percentage of cook, and kibble durability. What they have produced is a product that meets these needs, but additionally provides a more palatable product that provides additional nutritional benefits to the animal. Furthermore, fresh meat typically has a range of from 68 percent to 78 percent moisture content, sometimes within the supply used in one production run. Adding the inventive composition improves fresh meat consistency and controls viscosity.

The inventors developed a composition comprising from about 30 percent to about 80 percent fine-milled flax seed and from about 20 percent to about 70 percent whey protein concentrate (WPC), by weight, which, when admixed with meat, can be used to increase the amount of meat that can be incorporated into an extruded food product, such as an extruded pet food product. In various aspects, the composition may comprise from about 55 to about 70 percent fine-milled flaxseed and from about 30 to about 45 percent WPC.

The inventors have demonstrated that they can use the flaxseed/WPC composition to produce a pet food composition comprising from about 20 to about 90 percent by weight of at least one meat product, and a flaxseed/WPC component, wherein the flaxseed/WPC component comprises from about 30 percent to about 80 percent fine-milled flax seed and from about 20 Percent to about 70 percent WPC, by weight of the flaxseed/WPC component, and the flaxseed/WPC component is present in an amount of from about 1.5 percent to about 18.5 percent by weight of the meat. In certain aspects, such a pet food composition may comprise a flaxseed/WPC component comprising from about 55 to about 70 percent fine-milled flax seed and from about 30 to about 45 percent WPC, by weight of the flaxseed/WPC component.

The inventors have also developed a method for using the flaxseed/WPC composition to increase the meat content of an extruded food composition, the method comprising admixing the meat and a flaxseed/WPC component to form a meat/flaxseed/WPC mixture, the flaxseed/WPC component comprising from about 30 percent to about 80 percent fine-milled flaxseed and from about 20 percent to about 70 percent WPC, by weight of the flaxseed/WPC component, and the flaxseed/WPC component being added at from about 1.5 Percent to about 18.5 percent by weight of the meat; holding the mixture for from about 3 to about 30 minutes at from about 35 to about 60 degrees Celsius, and processing the mixture by extrusion cooking.

In some aspects of the invention, the flaxseed/WPC component is admixed with the meat and held at from about 45 to about 55 degrees Celsius, and in some aspects, the holding time is from about 10 minutes to about 30 minutes. In some aspects, the extruded food composition is an extruded pet food composition.

Heating a slurry, formed of the admixed ingredients, prior to extrusion, provides an added benefit in that it appears to decrease the dry density of the finished product (a desirable outcome, since more dense kibble tends to be more difficult to form into the desired shapes, easier to break into fines, etc.) and to increase the cook percentage. In Table 1, Run #101206-09 was performed without heating prior to adding the mix to the extruder and Run #101207-10 was performed by heating the mix to 50 degrees Celsius prior to adding it to the extruder.

TABLE 1

| | | | | Dry Density | |
|---|---|---|---|---|---|
| | Dry Recipe | Meat | OS 9000 | (g/l) Dry | % |
| Run # | Base+ | (% dry) | (% of meat) | Recipe Base+ | Cook |
| 101206-09 | Brown Rice | 43.5 | 16 | 516 | 70 |
| 101207-10 | Brown Rice | 43.5 | 16 | 368 | 80.2 |

Sources of whey protein include, for example, commercially-available whey protein concentrate, (Glanbia Nutritionals, Monroe, Wis.), which is made from fresh whey using ultrafiltration, then spray-dried to produce a product comprising about 78-80 percent protein. Sources of flaxseed may include, for example, full-fat milled flaxseed (Glanbia Nutritionals company, Monroe, Wis.), which provides flaxseed from Linum usitatissimum. Flaxseed has proven to be particularly effective for use in the inventive compositions and methods described by the inventors. Meat products may include any suitable meat for pet food kibble, including, but not limited to, mechanically deboned chicken (MDC), beef, turkey, buffalo, fish, and lamb.

Extrusion cooking processes for pet food are known to those of skill in the art. Extruders, such as those produced by Wenger® (Sabetha, Kans.) are commercially available, as are multiple publications related to conditions for their use. Briefly, by way of a non-limiting example, desired ingredients are generally ground to a particle size that is suitable for the product and its processing conditions. Dry ingredients may be mixed together as a first step, to form a dry mix, or dry ingredients may be processed through a grinder which deposits the ground material into a mixer. In the mixer, dry ingredients are mixed to an even consistency and particle distribution. Pre-conditioning involves the addition of heat and steam to the mix, and the pre-conditioned mix is then fed into either a single-screw or double-screw extruder, where the process of pushing the product through the confined space of the extruder increases the heat and pressure applied to the product. This heat and pressure produce gelatinization of cellulosic/starch (carbohydrates) components in the product. Extruded product is cut into desired shapes and dried in a drying oven, then cooled. Product (kibble) may then be coated with various desired coatings, such as fats/oils (often containing fat-soluble vitamins and other ingredients), probiotic microorganisms, etc. The coating process may be performed in a rotating drum, which produces force on the kibble sufficient to break it when high levels of starch, cellulose, and/or meat protein are present.

Additional breakage may occur as the result of packaging, packing for transportation, and shipping of product. The inventors have discovered, however, that the use an ingredient combination of flaxseed and whey protein, with the optional addition of milk mineral, produces a kibble product that is resistant to significant breakage and produces low levels (less than 1 percent) of fines, while being highly palatable to the dog and/or cat and providing increased nutritional value. The ingredient composition of the invention, comprising flaxseed and whey protein concentrate, binds with ground fresh meat, reduces its stickiness, and increases its ability to flow through the extruder. This results in a motor load reduction in the extruder, as shown in Table 2.

TABLE 2

| Sample | Motor Load | Extruder RPM |
|---|---|---|
| Control with 30% MDC, 0% | 42 | 481 |
| OptiSol 9000 (OS9000) | | |
| 30% MDC Test with 4% | 40 | 522 |
| OS9000/0.9% of formula | | |
| 30% MDC test with 8% | 38 | 522 |
| OS9000/1.8% of formula | | |
| 30% MDC Test with 12% | 41 | 481 |
| OS9000/2.7% of formula | | |
| 33% MDC Test with 12% | 47 | 522 |
| OS9000/2.7% of formula | | |

As shown in Table 2, at about 1.8 percent by weight of the formula, OptiSol 9000 (which contains the inventive composition comprising whey protein concentrate and flaxseed), reduces motor load by approximately ten percent and increases the RPM rate of the extruder by approximately 8-9 percent over the control without OptiSol 9000 (which should decrease production time and extend the life of the extruder motor).

It should be understood by those of skill in the art that a variety of additional ingredients may be added to a dry food product comprising meat, flax seed, and whey protein concentrate as described herein. Such ingredients may include, for example, vitamins, minerals, amino acids, plant extracts, and flavorings. Ingredients suitable for pet food compositions are known those of skill in the art of animal nutrition and pet food processing.

The addition of flax seed and whey protein concentrate as described by the inventors provides added nutritional benefits, in addition to providing a chemical/physical benefit in terms of facilitating the addition of higher meat levels. For example, about 28 percent of the weight of full-fat flax seeds is fiber, which is a beneficial level, but not a level that is likely to lead to increased stool volume. Animal feeding studies have demonstrated that compositions of the invention produce firm stools of a volume and color that is characteristic of good fermentation and nutrient absorption. Flaxseed also contains 8.5 to 39.5 mg/100 grams of gamma-tocopherols (gamma-tocopherol is a Vitamin E homolog that has multiple beneficial properties), as well as the omega-3 fatty acid alpha-linoleic acid and the omega-6 fatty acid linoleic acid. Flax is gluten-free and low in carbohydrates, as well. Whey protein supplies significant quantities of branched-chain amino acids and studies have shown that it has multiple desirable benefits in humans and animals, including promoting weight loss. Among the branched-chain amino acids provided by whey is the amino acid leucine, which is present at higher levels in whey proteins than in most other forms of protein. Leucine is beneficial for increased muscle synthesis and repair and provides a variety of other metabolic benefits, many of which have only recently been discovered.

The stronger individual kibbles produce by the composition of the invention and the method of the invention are both more resistant to breakage by the addition of external force and highly palatable. It is well-known in the pet food industry that the farther an animal's tooth sinks into the kibble, the greater the dental benefit, as dry kibble produces enough of an abrasive effect on the tooth to decrease the amount of tartar that may form there. Therefore, the dry food products produced using the ingredient composition of the invention and the method of the invention may provide an additional dental benefit for animals consuming these products.

Extruded and dried kibble may be subjected to significant force through the processes of coating, packaging, packing for transport, and storage of the product, which is most often packaged in bags of paper, foil, boxes, laminates or plastic. Compositions of the invention produce a product that withstands these forces sufficiently to produce levels of fines of less than about one percent, which may result in a cost savings due to the decreased need for physical measures to reduce breakage and decreased loss of product. Greater consumer satisfaction may also result from the decrease in residue in the bottom of an individual pet food bag.

Pet owners are well aware that the consistency and volume of an animal's feces are important to the owner in terms of convenience with which the feces may be disposed of, the overall amount of feces produced by the animal, etc. Even more importantly to most owners, good consistency, color, and reasonable volume are indicators of a pet's overall health and generally indicate that nutrients have been appropriately absorbed, the food promoting good fermentation and absorption within the intestines of the animal. Products produced by incorporating compositions of the invention have demonstrated their effectiveness at producing such desirable stool characteristics.

The invention may be further described by means of the following non-limiting examples.

### EXAMPLES

A dry mix was made, using 30.07 percent chicken meal, 2.1 percent catfish meal, 2.8 percent egg, 26.97 percent corn, 26.97 percent brown rice, 6.79 percent beet pulp, 2 percent yeast, 0.5 percent potassium chloride, 0.5 percent salt, 0.3 percent potassium sorbate, 0.45 percent vitamin premix, 0.1 percent TM 95, 0.1 percent choline chloride, 0.2 percent methionine, and 0.2 percent lysine by weight. This dry mix was used to produce a product comprising meat mix and dry mix, the various batches of meat mix comprising the ingredients listed in Table 3.

TABLE 3

| | Meat Source/Amount | OptiSol 9000* (Amount |
|---|---|---|
| | (expressed as percent of | expressed as percent of |
| Batch Number | total dry mix) | total dry mix) |
| 1 | MDC**/36.5 | None |
| 2 | MDC/36.5 | 3.5 |
| 3 | MDC/40 | 3.8 |
| 4 | MDC/50 | 4.8 |
| 5 | MDC/44.7 | 4.3 |
| 6 | MDC/44.7 | 8.6 |
| 7 | MDC/44.7 | 4.3 |
| | | (OptiSol 9000 substituted |
| | | with Pea Protein and |
| | | Potato Starch) |
| 8 | Buffalo/44.7 | 8.6 |
| 9 | Lamb/44.7 | 8.6 |
| 10 | MDC/50 | 8.6 |
| 11 | Buffalo/52 | 8.6 |
| 12 | MDC/44.7 | 8.6 |

*Optisol 9000 composition: 61.59 percent flaxseed, 38.41 percent whey protein concentrate.
MDC = mechanically deboned chicken.

What is claimed is:

1. A composition comprising from about 30 percent to about 80 percent fine-milled flax seed and from about 20 percent to about 70 percent whey protein concentrate (WPC), by weight.

2. The composition of claim 1 wherein the fine-milled flax seed is present at from about 55 to about 70 percent, and the whey protein concentrate is present at from about 30 to about 45 percent, by weight.

3. A pet food composition comprising from about 20 to about 90 percent by weight of at least one meat product, and a flaxseed/whey protein concentrate component, wherein the flaxseed/whey protein concentrate component comprises from about 30 percent to about 80 percent fine-milled flax seed and from about 20 Percent to about 70 percent whey protein concentrate, by weight of the flaxseed/whey protein concentrate component, and the flaxseed/whey protein concentrate component is present in an amount of from about 1.5 percent to about 18.5 percent by weight of the meat.

4. The composition of claim 3 wherein the flaxseed/WPC component comprises from about 55 to about 70 percent fine-milled flax seed and from about 30 to about 45 percent whey protein concentrate.

5. A method for increasing the meat content of an extruded food composition, the method comprising
a) admixing a meat product and a flaxseed/whey protein concentrate component to form a meat/flaxseed/whey protein concentrate mixture, the flaxseed/whey protein concentrate component comprising from about 30 percent to about 80 percent fine-milled flaxseed and from about 20 percent to about 70 percent whey protein concentrate, by weight of the flaxseed/whey protein concentrate component, and the flaxseed/whey protein concentrate component being added at from about 1.5 percent to about 18.5 percent by weight of the meat;
b) holding the mixture for from about 3 to about 30 minutes at from about 35 to about 60 degrees Celsius; and
c) processing the mixture by extrusion cooking.

6. The method of claim 5, wherein the flaxseed/whey protein concentrate component is admixed with the meat and held at from about 45 to about 55 degrees Celsius.

7. The method of claim 5, wherein the admixture is held from about 10 minutes to about 30 minutes.

8. The method of claim 5, wherein the extruded food composition is an extruded pet food composition.
